(19) United States
(12) Patent Application Publication
(10) Pub. No.: US 2025/0030447 A1
(43) Pub. Date: Jan. 23, 2025

(54) WEARABLE DEVICE FOR DETECTING AND COMMUNICATING RADIO FREQUENCY EMISSIONS AND RELATED METHODS

(71) Applicant: Metrea Management LLC, Washington, DC (US)

(72) Inventors: Kristian Westfall, Westminster, MD (US); Joseph I. Farina, Eldersburg, MD (US)

(21) Appl. No.: 18/380,035

(22) Filed: Oct. 13, 2023

Related U.S. Application Data
(60) Provisional application No. 63/528,050, filed on Jul. 20, 2023.

(51) Int. Cl. H04B 1/3827; G01S 19/01; G04G 21/04; G08B 5/22; G08B 7/06

(52) U.S. Cl. CPC H04B 1/385; G01S 19/01; G04G 21/04; G08B 5/228; G08B 7/06

(57) ABSTRACT

An autonomous wearable radio frequency (RF) detection device for detecting cellular, Wi-Fi, or Bluetooth radio frequency emissions and locations. The wearable device is operable to detect RF signals in a proximal area surrounding the wearable device and a user wearing the wearable device and communicate the information to a user. Leveraging a cloud based system, the wearable RF detection device can relay RF signal information to a cloud network for correlation with known RF signal sources, and receive back indications of known and rogue RF signal sources among the detected RF signals in the proximal area.

### CROSS-REFERENCE TO RELATED APPLICATION(S)

This application claims priority to, and the benefit of, co-pending U.S. Provisional Application 63/528,050, filed Jul. 20, 2023, for all subject matter common to both applications. The disclosure of said provisional application is hereby incorporated by reference in its entirety.

### FIELD OF THE INVENTION

The present invention relates to a wearable device operable to detect radio frequency (RF) signals in a proximal geolocation surrounding the wearable device and user. In particular, the present invention relates to the wearable device in which RF signals are received, information concerning those RF signals is collected, and a real-time or near real-time communication of RF signals existing in the proximal geolocation area surrounding the user of the wearable device is provided to the user.

### BACKGROUND

In the modern world, radio frequency (RF) signals are ubiquitous, being used in a wide range of applications, from mobile communications to wireless networking. These signals are transmitted from various sources, such as cell towers, Wi-Fi routers, and Bluetooth devices. However, not all RF signals are benign. Some may be rogue signals, transmitted by unauthorized or malicious sources. These rogue signals can pose a threat to the security and privacy of individuals and organizations.

Traditional RF detection systems are typically stationary and complex, requiring specialized equipment and trained personnel to operate. These systems are not suitable for everyday use by ordinary individuals. Furthermore, they are not capable of providing real-time or near-real-time detection and notification of rogue RF signals.

### SUMMARY

There is a need for a portable, user-friendly RF detection system that can provide real-time or near-real-time detection and notification of RF signals, including rogue signals. The system should be capable of processing RF signal data and communicating information concerning the detected signals to the user. It should also be capable of transmitting the RF signal data to a cloud computing system for further analysis and action.

The present invention addresses these needs by providing an autonomous wearable RF detection device, a method for detecting RF signals using the wearable device, and a system for detecting RF signals. The wearable device includes one or more hardware devices configured to receive and process RF signals from a proximal area surrounding the wearable device, and one or more software modules installed on the wearable device, configured to access the RF signals received by the hardware devices and collect RF signal data.

The wearable device also is configured to provide real-time or near-real-time communication of information to a user concerning the detected RF signals, a wireless transmission module is configured to transmit the RF signal data to a cloud computing system, and a notification module is configured to communicate RF signal source location information to the user.

The cloud computing system is configured to receive the RF signal data from the wearable device, determine the geographic map location of the RF signal sources using the RF signal data, and communicate information concerning the detected RF signals back to the wearable device. The system can also compare the RF signal source locations with a database of known RF signal locations to identify whether a received RF signal from an RF signal source correlates to a known RF signal source location, and label a received RF signal from an RF signal source that does not correlate to a known RF signal source location with an identifier indicating a rogue RF signal source.

The wearable RF detection device also includes one or more software modules installed on the wearable device. These software modules are configured to access the RF signals received by the hardware devices and collect RF signal data. The wearable RF detection device further is configured to provide real-time or near-real-time communication of information to a user concerning the RF signals detected according to some embodiments. The wearable RF detection device also includes a wireless transmission module. This module is configured to transmit the RF signal data to a cloud computing system. The wearable RF detection device also includes a notification module. This module is configured to communicate RF signal source location information to the user.

In some embodiments, the wearable RF detection device may be a smartwatch containing specialized software. In other embodiments, the one or more software modules may be supported by operating system software, such as Android OS, WatchOS, or equivalents.

In some embodiments, the RF signal data is processed on the wearable device to communicate to the user RF signals being received in a proximal area surrounding the wearable device.

In some embodiments, the cloud computing system comprises a plurality of servers interconnected by a network. This system is configured to collect the RF signal data and determine the geographic map location of the RF signal sources using the RF signal data.

In some embodiments, the RF signal source locations are compared with a database of known RF signal locations to identify whether a received RF signal from an RF signal source correlates to a known RF signal source location.

In some embodiments, a received RF signal from an RF signal source that does not correlate to a known RF signal source location is labeled with an identifier indicating its unknown rogue status. This information is communicated from the cloud computing system back to the wearable device as a rogue RF signal source.

In some embodiments, the notification module comprises a display configured to display RF signal source location information and/or a notification module configured to notify the user of the RF signal source location information. The wearable device displays the location of the rogue RF signal source on a display of the wearable device, and/or provides an audible alert or other notification indicating the existence of the rogue RF signal source using the notification module.

In some embodiments, the RF signals are selected from a group of different protocols comprising, 2G, 3G, 4G, 5G, Bluetooth®, and Wi-Fi.

In some embodiments, the wearable device includes a Global Positioning System (GPS) antenna for satellite-based navigation to aid in providing location data of the wearable device.

The present disclosure also relates to an example embodiment of a method for detecting RF signals using a wearable device. This method includes the steps of receiving RF signals from a proximal area surrounding the wearable device, accessing the RF signals received and collecting RF signal data using one or more software modules installed on the wearable device, providing real-time or near-real-time communication of information to the user concerning the RF signals detected, transmitting the RF signal data to a cloud computing system, and displaying and/or notifying the user of the location of RF signal sources.

The present disclosure also relates to an example embodiment of a system for detecting RF signals. This system includes a wearable RF detection device as claimed in claim 1, and a cloud computing system configured to receive RF signal data from the wearable device, determine the geographic map location of the RF signal sources using the RF signal data, and communicate information concerning the RF signals detected back to the wearable device.

In some embodiments, the cloud computing system is further configured to compare the RF signal source locations with a database of known RF signal locations to identify whether a received RF signal from an RF signal source correlates to a known RF signal source location, and label a received RF signal from an RF signal source that does not correlate to a known RF signal source location with an identifier indicating a rogue RF signal source.

The present invention provides a practical and effective solution for real-time or near-real-time detection and notification of RF signals, including rogue signals. It is portable, user-friendly, and suitable for everyday use by individuals. It enhances the security and privacy of individuals and organizations by enabling them to detect and respond to rogue RF signals in a timely manner.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of the wearable RF detection device, showing the hardware devices, software modules, wireless transmission module, and notification module;

FIG. 2 is a systemic diagram of a cloud computing system, the process of collecting RF signal data, and the process of determining the geographic map location of the RF signal sources, and the process of communication information concerning the RF signals detected back to the wearable device;

FIG. 3 is a representation of the wearable RF detection device showing a display notification;

FIG. 4 is a representation of a graphical display showing a geographical map location of a plurality of RF signal sources in proximal area surrounding the wearable RF detection device; and

FIG. 5 is a flow diagram of the process of receiving RF signals, accessing the RF signal data, providing communication information to the user concerning the RF signals, transmitting the RF signal data to a cloud computing system, comparing the RF signal source locations with a database of known RF signal locations, identifying unknown RF signal sources, and communicating the rogue RF signal source information back to the wearable device.

### DETAILED DESCRIPTION

An illustrative embodiment of the present invention relates to a wearable radio frequency (RF) detection device includes hardware devices configured to receive and process RF signals from a proximal area surrounding the wearable device, software modules installed on the wearable device, a wireless transmission module, and a notification module. The proximal area is generally defined by the area around the wearable RF detection device that is within range of an RF source for the particular RF signal protocol being detected. The software modules are configured to access the RF signals received by the hardware devices and collect RF signal data. The wearable device is configured to provide real-time or near-real-time communication of information to a user concerning the RF signals detected in accordance with one embodiment. The wireless transmission module is configured to transmit the RF signal data to a cloud computing system. The notification module is configured to communicate RF signal source location information to the user in a desired form, such as via a visual display, an audible or tactile indicator, or combinations thereof.

Notably, the wearable RF detection device enables wireless RF detection.

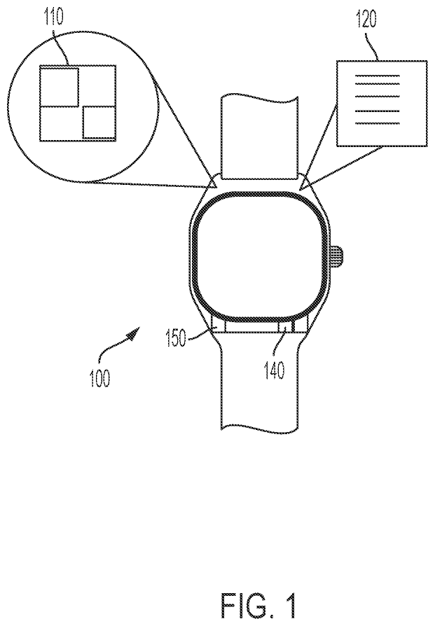

FIGS. 1 through 5, wherein like parts are designated by like reference numerals throughout, illustrate an example embodiment or embodiments of an autonomous wearable RF detection device, and corresponding system and method, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed in a manner still in keeping with the spirit and scope of the present invention.

The present disclosure relates to an example embodiment of a wearable radio frequency (RF) detection device 100. This device includes one or more hardware devices configured to receive and process RF signals from a proximal area surrounding the wearable device. As utilized herein, proximal area refers to an area within a range of the wearable device that correlates to the distance a particular RF signal travels. For example, the present invention is capable of detecting many different RF signals, including 2G, 3G, 4G, 5G, Bluetooth®, and Wi-Fi. More specifically with regard to the cellular protocols, 2G, understood as GSM and CdmaOne, 3G (UMTS/CDMA2000), 4G (LTE) and the newest is 5G. Generally, a Bluetooth® signal will have a much shorter range and therefore a much closer proximity definition to the wearable device, vs. any of the cellular protocols (2G through 5G), which would have a much greater proximity distance from the wearable device, with Wi-Fi coming between the others in terms of distance. The proximal area is the area defined by the overlap of the transmitted signal area of the particular RF signal with the ability of the wearable device to sense the signal. If a wearable device is 1 mile from a Bluetooth® RF signal, the wearable device will not be able to sense the RF signal because it is too far away—outside of the proximal area of the wearable device, whereas the same distance may result in the wearable device sensing a 4G cellular signal, which would then be within the proximal area of the wearable device for that particular RF protocol.

Turning to FIG. 1, Hardware Devices 110: These are the physical components of the wearable device 100, such as a smartwatch. They are responsible for receiving the RF signals from the surrounding area.

Software Modules 120: These are specialized software installed on the wearable device 100. They access the hardware antenna RF signals received by the wearable device 100 and collect RF signal data. This data can be processed on the wearable device 100 to communicate to the user the RF signals being received in a proximal area surrounding the wearable device.

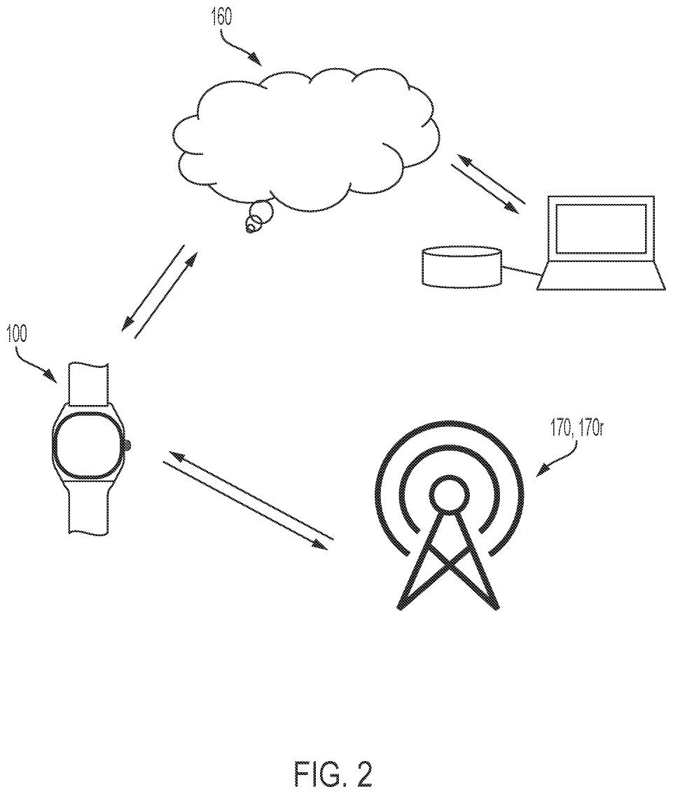

Wireless Transmission Module 140: This module is responsible for transmitting the RF signal data wirelessly to a cloud computing system. The cloud computing system collects the RF signal data and determines the geographic location of RF signal sources 170 (shown in FIG. 2) using the RF signal data.

Notification Module 150: This module is responsible for outputting or displaying the location of the rogue RF signal source 170r on a display of the wearable device, and/or providing other notifications, such as an audible alert, tactile alert, or other notification indicating the existence of the rogue RF signal source. The display of the rogue RF signal source and any additional notification can occur in real-time or near-real-time between the sensing of the RF signal and the display or notification by the wearable device to the user.

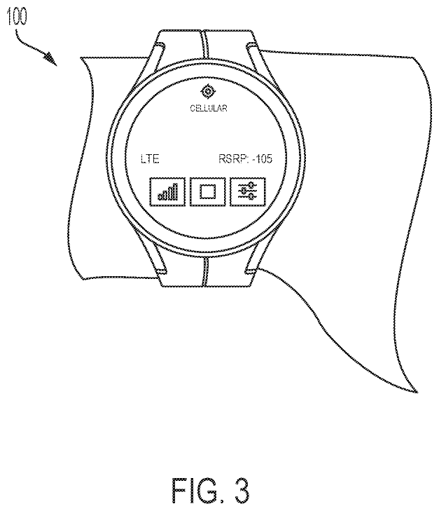

This figure provides a detailed view of the wearable RF detection device embodied as a smartwatch (also shown in FIG. 3). The smartwatch is equipped with specialized software 120 and operating system software. The smartwatch is a wearable device 100 that is capable of detecting and receiving RF signals from its surrounding area. It is autonomous and wireless, and can be a product of various manufacturers such as Samsung or Apple or Google. It is designed to operate on different operating systems like Android OS or WatchOS. In certain embodiments, it may further include a Global Positioning System (GPS) antenna for satellite-based navigation.

The specialized software 120 is installed on the smartwatch and is responsible for accessing the hardware antenna RF signals received by the wearable device and collecting RF signal data. This data can be processed on the device itself or transmitted to a cloud computing system for further analysis and processing. Example software for use as the specialized software is a watch operating system version of Echo One provided by Enhancell Ltd., though other equivalent software providing equivalent features can be utilized in conjunction with the present invention.

The operating system software supports the functioning of the smartwatch and the specialized software. It enables the smartwatch to operate and execute the functions as described in the claims, such as detecting RF signals, processing RF signal data, and communicating information to the user.

FIG. 2 shows a system diagram that shows the interaction between the wearable RF detection device 100 and a cloud computing system 160. The wearable RF detection device in this example embodiment is a smartwatch (as shown in FIG. 3) or similar device that is capable of detecting and receiving RF signals from its surrounding area. It collects information about these signals and transmits this data wirelessly to the cloud computing system. This device is autonomous and wireless, and it can process the RF signal data to communicate to the user about the RF signals being received in the proximal area surrounding the wearable device.

The cloud computing system 160 is conventionally a network of interconnected servers that receives the RF signal data from the wearable device, but any remote cloud computing device or system can be utilized. In one embodiment, it processes this data to determine the geographic location of the RF signal sources 170. The system can also compare the RF signal source locations with a database of known RF signal locations to identify whether a received RF signal correlates to a known RF signal source location or not. If the RF signal source does not correlate to a known RF signal source location, it is labeled as a “rogue RF signal source” 170r. This information is then communicated back to the wearable device.

The wearable device can display the location of the rogue RF signal source 170r on its display, and/or provide other notifications such as an audible alert to the user. This display or notification can occur in real-time or near-real-time after the RF signal is detected.

Those of skill in the art will appreciate that in an alternative embodiment, it may be preferable for the wearable device 100 to collect the RF signal data and not emit any electronic transmissions while the data is being collected. In some embodiments, the RF signal data may be stored, processed, or otherwise analyzed on the wearable device. In some such embodiments, the wireless transmission module 140 can be deactivated so as to not transmit RF signal data to the cloud computing system 160. The RF signal data could later be downloaded from the wearable device 100, or the wireless transmission module 140 could be later activated and the RF signal data wirelessly transmitted to the cloud computing system 160, or wherever analysis is to occur, and analyzed as described elsewhere in here.

Those of skill in the art will further appreciate that the various claimed modules are provided to refer to the required functionality. The modules can be software, hardware, or combinations thereof, and can be combined or divided into one or more hardware or software modules as one of ordinary skill would be able to configure.

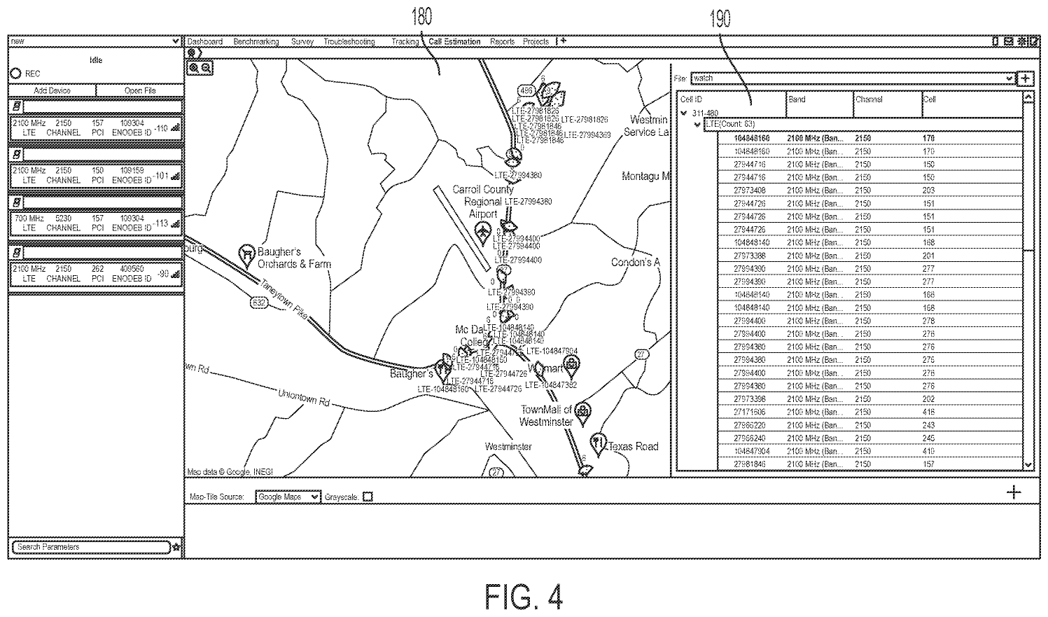

FIG. 4 is a representative illustration of a display showing geographic location data in a map 180 along with an indication of the RF signal characteristics 190. This data and information can be analyzed as needed, including for RF signal source survey purposes, or also for purposes of identifying rogue RF signal sources, as described elsewhere herein.

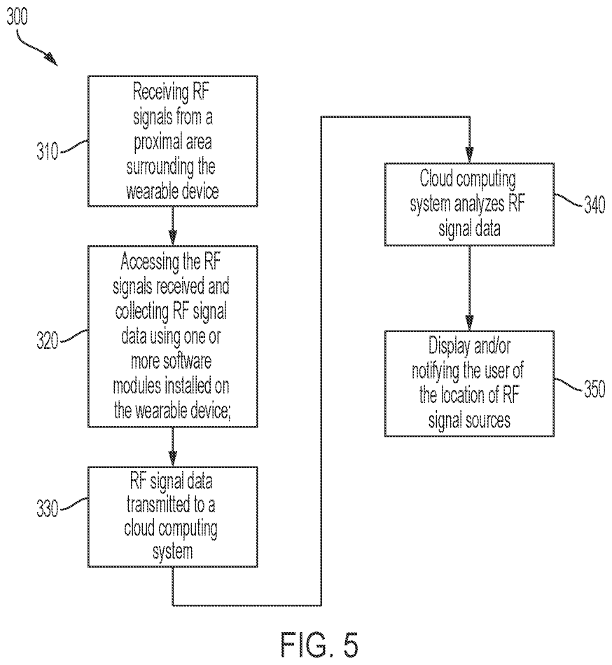

FIG. 5 is a flow diagram illustrating the process 300 of the wearable device's operation in accordance with one example embodiment of the present invention.

The process 300 includes receiving and processing of RF signals (step 310). This is where the wearable device, such as a smartwatch, detects and collects data from RF signals in the proximal area surrounding the device. The RF signals can be of various protocols, including 2G, 3G, 4G, 5G, Bluetooth, Wi-Fi, etc., which define the applicable proximal area as discussed above (the proximal area around a wearable device that can detect the RF signal will be greater for RF signals with larger transmission distances, and lesser for RF signals with shorter transmission distances).

The RF signals received are accessed RF signal data collected using one or more software modules installed on the wearable device (step 320).

The RF signal data, according to example embodiments, transmitted to a cloud computing system (step 330).

The cloud computing system compares a list of known RF signal sources with the RF signal data to correlate known RF signal sources and identify unknown rogue RF signal sources (step 340).

The cloud computing system transmits the information back to the wearable device (step 350). The information transmitted back can take any preferred form. For example, it may include all RF signal source locations, only known RF signal source locations, only unknown Rogue signal source locations, or combinations of any of these.

The wearable device displays and/or notifies the user of the location of RF signal sources according to the desired configuration (step 350). In certain embodiments, the wearable device may make use of GPS functionality of the wearable device to further aid in providing location data.

To elaborate, if a received RF signal does not correlate to a known RF signal source location, it is labeled as a “rogue RF signal source”. This identifier of rogue status is then communicated back to the wearable device, which displays the location of the rogue RF signal source to the user and/or provides an audible alert or other notification. This notification can occur in real-time or near-real-time according to some example embodiments.

In accordance with an alternative embodiment, the wearable RF detection device 100 can further leverage the capabilities described herein to send out a transmission. The transmission can be an emergency SOS signal wherein the user can easily select the transmission to go out, e.g., wirelessly to the cloud, and the transmission can include one or more of GPS location data, time data, detected RF signal data collected, detected rogue RF signal sources, and any other information or data that can reasonably be determined from the configurations and protocols described herein.

To any extent utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

1. An autonomous wearable radio frequency (RF) detection device, comprising:
one or more hardware devices configured to receive and process RF signals from a proximal area surrounding the wearable device;
one or more software modules installed on the wearable device, configured to access the RF signals received by the hardware devices, and collect RF signal data;
a wireless transmission module configured to transmit the RF signal data to a cloud computing system; and
a notification module configured to communicate RF signal source location information to a user of the autonomous wearable radio frequency (RF) detection device.

2. The wearable RF detection device of claim 1, wherein the wearable RF detection device comprises a smartwatch having specialized software.

3. The wearable RF detection device of claim 1, wherein the RF signal data is processed on the wearable device to communicate to the user of the autonomous wearable radio frequency (RF) detection device RF signals being received in a proximal area surrounding the wearable device.

4. The device of claim 3, wherein the wireless transmission module is configured so as to not transmit the RF signal data to the cloud computing system while the RF signal data is being collected.

5. The wearable RF detection device of claim 1, wherein the cloud computing system comprises a plurality of servers interconnected by a network, configured to determine a geographic location of a source of the RF signal using the RF signal data.

6. The wearable RF detection device of claim 1, wherein the RF signal source locations are compared with a database of known RF signal locations on the cloud computing system to identify whether a received RF signal from an RF signal source correlates to a known RF signal source location.

7. The wearable RF detection device of claim 6, wherein a received RF signal from an RF signal source that does not correlate to a known RF signal source location is labeled with an identifier indicating its unknown rogue status and communicated from the cloud computing system back to the wearable device as a rogue RF signal source.

8. The wearable RF detection device of claim 7, wherein the notification module comprises a display configured to display RF signal source location information and/or a notification module configured to notify the user of the RF signal source location information with an audible or tactile indicator, and wherein the wearable device displays the location of the rogue RF signal source on a display of the wearable device, and/or provides an audible and/or tactile alert indicating existence of the rogue RF signal source using the notification module.

9. The wearable RF detection device of claim 1, wherein the RF signals are selected from a group of different protocols comprising, 2G, 3G, 4G, 5G, Bluetooth®, and Wi-Fi.

10. The wearable RF detection device of claim 1, wherein the wearable device includes a Global Positioning System (GPS) antenna for satellite-based navigation to aid in providing location data of the wearable device.

11. The wearable RF detection device of claim 1, wherein the device is configured to provide real-time or near-real-time communication of information to the user of the autonomous wearable radio frequency (RF) detection device concerning the RF signals detected.

12. The device of claim 1, wherein the wearable RF detection device is configured to send out a transmission, wherein the transmission comprises an emergency SOS signal.

13. The device of claim 12, wherein the emergency SOS signal comprises one or more of detected RF signal data collected, and detected rogue RF signal sources.

14. A method for detecting RF signals using a wearable device, comprising the steps of:
receiving RF signals from a proximal area surrounding the wearable device;
accessing the RF signals received and collecting RF signal data using one or more software modules installed on the wearable device;
transmitting the RF signal data to a cloud computing system;
displaying to and/or notifying a user of the wearable device of a location of RF signal sources.

15. The method of claim 14, further comprising the step of processing the RF signal data on the wearable device to communicate to the user of the wearable device RF signals being received in a proximal area surrounding the wearable device.

16. The method of claim 14, further comprising the step of determining a geographic map location of a source of the RF signal using the RF signal data collected by the cloud computing system.

17. The method of claim 14, further comprising the step of comparing the RF signal source locations with a database of known RF signal locations to identify whether a received RF signal from an RF signal source correlates to a known RF signal source location.

18. The method of claim 17, further comprising the step of labeling a received RF signal from an RF signal source that does not correlate to a known RF signal source location with an identifier indicating its unknown rogue status and communicating the identifier from the cloud computing system back to the wearable device as a rogue RF signal source.

19. The method of claim 18, further comprising the step of displaying the location of the rogue RF signal source on a display of the wearable device, and/or providing an audible and/or tactile alert indicating existence of the rogue RF signal source.

20. The method of claim 14, wherein the RF signals are selected from a group of different protocols comprising, 2G, 3G, 4G, 5G, Bluetooth®, and Wi-Fi.

21. The method of claim 14, wherein the wearable device includes a Global Positioning System (GPS) antenna for satellite-based navigation to aid in providing location data.

22. The method of claim 14, wherein the device is configured to provide real-time or near-real-time communication of information to the user of the wearable device concerning the RF signals detected.

23. The method of claim 14, wherein the wearable RF detection device is configured to send out a transmission, wherein the transmission comprises an emergency SOS signal.

24. The method of claim 23, wherein the emergency SOS signal comprises one or more of detected RF signal data collected, and detected rogue RF signal sources.

25. A system for detecting RF signals, comprising:
an autonomous wearable radio frequency (RF) detection device, comprising:
one or more hardware devices configured to receive and process RF signals from a proximal area surrounding the wearable device;
one or more software modules installed on the wearable device, configured to access the RF signals received by the hardware devices and collect RF signal data;
a wireless transmission module configured to transmit the RF signal data to a cloud computing system; and
a notification module configured to communicate RF signal source location information to a user of the autonomous wearable radio frequency (RF) detection device; and
a cloud computing system configured to receive RF signal data from the wearable device, determine a geographic location of a source for the RF signal using the RF signal data, and communicate information concerning the RF signals detected back to the wearable device.

26. The system of claim 25, wherein the cloud computing system is further configured to compare the RF signal source locations with a database of known RF signal locations to identify whether a received RF signal from an RF signal source correlates to a known RF signal source location, and label a received RF signal from an RF signal source that does not correlate to a known RF signal source location with an identifier indicating a rogue RF signal source.

27. The system of claim 25, wherein the wearable RF detection device is configured to send out a transmission, wherein the transmission comprises an emergency SOS signal.

28. The system of claim 27, wherein the emergency SOS signal comprises one or more of detected RF signal data collected, and detected rogue RF signal sources.

29. A system for detecting RF signals, comprising:
an autonomous wearable RF detection device, comprising:
one or more hardware devices configured to receive and process RF signals;
one or more software modules installed on the wearable device, configured to access the RF signals received by the hardware devices and collect RF signal data from a proximal area surrounding the wearable device; and
a wireless transmission module configured to transmit the RF signal data, and wearable device location data, to a computing system; and
a computing system configured to receive RF signal data from the wearable device, and determine a geographic location of a source of the RF signal based on the RF signal data and the wearable device location data corresponding with receipt of the RF signals.

30. The system of claim 29, wherein the autonomous wearable device further comprises a notification module to communicate to a user the existence of a received RF signal source that does not correlate to a known RF signal source location.
